(19) United States
(12) Patent Application Publication
(10) Pub. No.: US 2025/0391097 A1
(43) Pub. Date: Dec. 25, 2025

(54) PARALLEL MULTI-CLIENT RAY TRACING TASK PROCESSING

(71) Applicant: Advanced Micro Devices, Inc, Santa Clara, CA (US)

(72) Inventors: Aaron Michael Knoll, Millcreek, UT (US); Binh Huy Le, Santa Clara, CA (US); Madhusudhanan Srinivasan, Austin, TX (US); Mark Richard Nutter, Austin, TX (US)

(21) Appl. No.: 18/751,915

(22) Filed: Jun. 24, 2024

(51) Int. Cl. G06T 15/06; G06T 15/00

(52) U.S. Cl. CPC G06T 15/06; G06T 15/005

(57) ABSTRACT

A server employs shared ray tracing data to generate video streams for multiple client devices in parallel. The server receives requests to perform ray tracing tasks for multiple client devices to depict at least respective portions of a scene, uses the shared ray tracing data to perform ray tracing operations for each of the client devices, based on the ray tracing operations generates different sets of image frames, and streams each set of image frames to a corresponding client device over a network.

### BACKGROUND

Streaming video has become an increasingly popular method of delivering content to users. For example, streaming video content (e.g., game content or high-definition video content) from a server to one or more client devices over a network allows for the delivery of sophisticated or complex images without requiring each client device to have powerful image generating hardware, such as a computer with a powerful graphics processing unit (GPU) or a game console. To increase efficiency, each server of a typical game content or other streaming system streams video content to multiple clients. Conventionally, this multi-client streaming is implemented via an instanced computing environment, where each client device is assigned a separate program instance (e.g., separate game instance) that generates the corresponding video stream for the client device. However, this approach consumes a high amount of server resources, particularly as the number of client devices increases.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a video streaming system that shares a ray tracing context among multiple client devices in accordance with some implementations.

FIG. 2 is a block diagram of a ray tracing context of a video streaming system in accordance with some implementations.

FIG. 3 is a diagram of an example group of client tasks used to generate frames of a scene for multiple client devices in accordance with some implementations.

FIG. 4 is a flow diagram illustrating an example of a video streaming system generating frames of a ray tracing context for multiple client devices in parallel in accordance with some implementations.

FIG. 5 is a flow diagram of a method of generating multiple streams of frames of a ray tracing context for multiple client devices in parallel in accordance with some implementations.

FIG. 6 is a block diagram of a processing system that implements a server of a video streaming system that generates frames of a ray tracing context for multiple client devices in parallel in accordance with some implementations.

### DETAILED DESCRIPTION

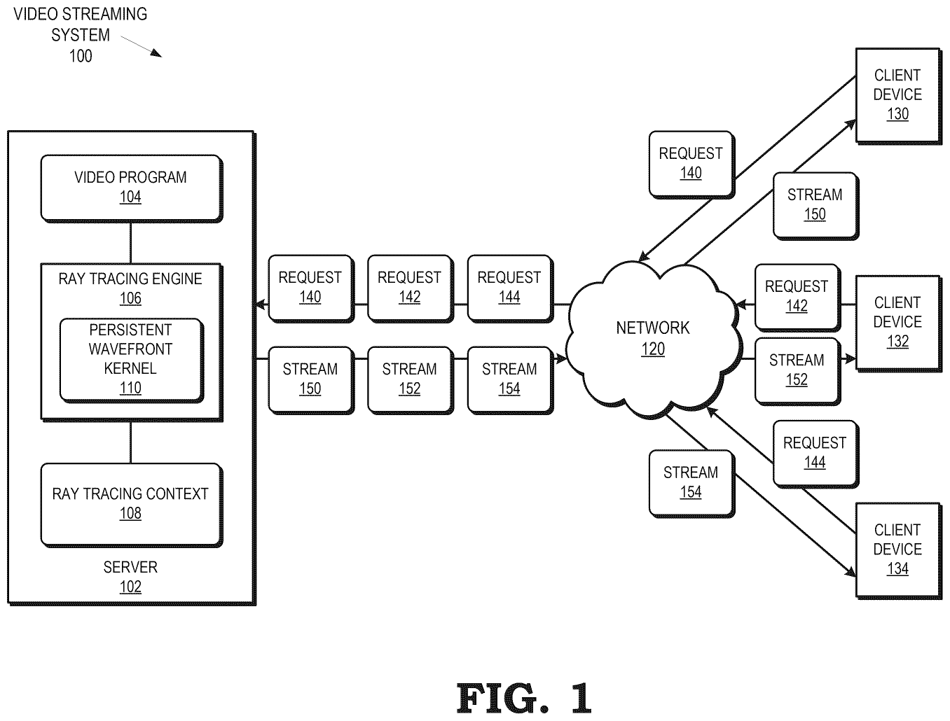

FIGS. 1-6 illustrate systems and techniques for performing ray tracing operations in parallel to generate video streams (e.g., video streams produced as part of the rendering of video game images) for multiple client devices. In some implementations, when multiple clients request ray tracing within a same ray tracing context (e.g., ray tracing of a same scene using similar or the same scene data, a same bounding volume hierarchy (BVH), or both), at least some ray tracing tasks are performed in parallel (e.g., via batch processing). In some cases, processing resources that would be unused by a system that processes multiple ray tracing tasks of a single client device in parallel are instead utilized by a system (e.g., a cloud-based system) that processes multiple tasks of multiple client devices in parallel. In some cases, higher occupancy results in a higher average throughput for the system.

To illustrate via an example, a game streaming system includes a server (e.g., a processing server) that executes a game program. The game program receives input data from a client device over a network, and based on the input data sends commands to a graphics processing unit (GPU) of the server to generate image frames. At least some of these commands instruct the GPU to perform ray tracing operations based on a ray tracing context. For example, in some cases the ray tracing context includes a BVH, and the game program issues commands for the GPU to perform traversal operations—that is, commands for the GPU to traverse the BVH in order to identify the intersection of rays with one or more objects of a scene. Based on the traversal of the BVH and the identified ray intersections, the GPU generates one or more image frames, and the server streams or otherwise sends the image frames to the client device over the network.

To use the resources of the server more efficiently, it is useful for the server to generate and stream image frames for multiple client devices. Conventionally, this is done by the server employing a separate game program instance, and corresponding graphics context, for each client device. For example, some servers implement a virtualized computing environment, where the server executes a different virtual machine (VM) for each client device. Each VM executes a different instance of the game program, and each of the different game program instances employs a separate copy of the ray tracing context, including a different copy of the BVH.

Some systems process multiple ray tracing tasks for a given client device or VM in parallel. Ray tracing tasks include the processing of primary rays, which travel from a ray origin to potential objects within a scene, and secondary rays, which are spawned from primary rays or other secondary rays, that generally result from rays bouncing off objects within the scene. In some implementations, secondary rays are used to determine whether a given location is in shadow or to compute shading effects such as reflection or refraction. In some cases, different primary rays trace different paths and cause different quantities of secondary rays to be generated (e.g., due to Russian Roulette, missed next event estimation/shadows, or other causes). In some implementations, a long-tail problem ensues in which some ray tracing tasks (e.g., tasks involving a relatively large number of secondary rays) take longer to process than other ray tracing tasks (e.g., tasks involving a relatively small number of secondary rays). As a result, in some cases, if a processing system processes multiple ray tracing tasks in parallel and one task finishes significantly earlier than another task, the processing system experiences undesirable occupancy due to waiting for some incomplete ray tracing tasks. Even with systems that have a maximum of five bounce paths, which is generally a minimum amount used to provide photorealism, occupancy for the fourth and fifth bounces is frequently less than ten percent. However, in some services, such as games, multiple client devices request tracing of a similar number of rays, both in terms of primary rays and secondary rays, to display a particular scene. In some cases, the client devices request tracing a similar number of rays even if the scene is viewed from slightly different perspectives.

Using the techniques and systems described herein, a game streaming system or other video streaming system employs a single graphics context (e.g., ray tracing data for a scene), including one or more of a BVH, scene graph, device driver, geometry data, and texture data, to generate image frames for multiple client devices in parallel. For example, in response to receiving requests to depict at least a respective portion of a scene for each of the multiple client devices, the server causes a rendering engine of the GPU to traverse the same instance of the BVH for multiple the multiple client devices in parallel, where the particular traversal operation and results depend upon corresponding program state information (e.g., game state) information for each of the multiple client devices. In some cases, the rendering engine processes similar bounces for different rays in parallel (e.g., a shadow ray of a first ray in parallel with a shadow ray of a second ray). In some cases, the rendering engine processes different bounces for different rays in parallel (e.g., a second bounce of a first ray in parallel with a fifth bounce of a second ray). In some cases, the different rays trace different paths even if they have a same origin point in a same scene.

To illustrate, in some implementations, a game program executing at the server maintains a different game state for each client device, where the game state for a given client device indicates the position of a character corresponding to the client device. In some cases, the position of the character varies between at least some client devices, reflecting different user interactions with the game program. The rendering engine traverses the same BVH for each client device based upon the corresponding character position as indicated by the corresponding game state. The server thereby generates image frames for streaming to multiple client devices based upon the same graphics context. However, in some cases, the resulting images differ from client device to client device. Further, the image frames are generated in parallel as a result of parallel ray tracing tasks. As a result, server resources are conserved and occupancy is increased, as compared to a system that provides each client device a separate virtual machine. In some implementations, image tiles (portions of image frames) are generated rather than image frames. For clarity, this description refers to generation of image frames. However, as used herein, the generation of frames herein should be understood to also describe the generation of tiles.

For purposes of description, FIGS. 1-6 are described with respect to examples where ray tracing operations are implemented at a graphics processing unit (GPU). However, it will be appreciated that, in other implementations, the techniques described herein are implemented at different types of processing circuits, are implemented to traverse a different type of acceleration structure, or any combination thereof. For example, in various implementations, the techniques described herein are implemented at one or more vector processors, coprocessors, GPUs, general-purpose GPUs (GPGPUs), non-scalar processors, highly parallel processors, artificial intelligence (AI) processors, inference engines, machine-learning processors, other multithreaded processing units, scalar processors, serial processors, programmable logic devices (simple programmable logic devices, complex programmable logic devices, field programmable gate arrays (FPGAs), application specific integrated circuits, or any combination thereof.

FIG. 1 illustrates a cloud-based video streaming system 100 that shares a ray tracing context among multiple client devices with some implementations. Video streaming system 100 includes a video streaming service composed of server 102 (e.g., a processing server) connected to client devices 130, 132, and 134 via one or more networks 120. Server 102 includes at least one video program 104 (e.g., a video game program or a video streaming program), ray tracing engine 106, and at least one ray tracing context 108. Ray tracing engine 106 includes persistent wavefront kernel 110. Client devices 130, 132, and 134 include, or are otherwise connected to, corresponding display devices (not shown). In various implementations, video streaming system 100 includes any of a variety of cloud-based services that provide streamed multimedia content to client devices 130, 132, and 134. One example of such a service includes cloud-based video gaming, and video streaming system 100 is described in further detail herein with reference to this example for ease of illustration. However, it will be appreciated that the techniques described herein are not limited to cloud-based video gaming services, but instead is implementable for any of a variety of systems in which rendered video streams are remotely generated and transmitted to client devices 130, 132, and 134.

In some implementations, server 102 includes one or more servers co-located at a same server site or one or more servers located at geographically separated server sites. For ease of illustration, functionality implemented at the server-side of video streaming system 100 is described in the context of a single server 102 performing the corresponding functionality. However, it will be appreciated that in some implementations, the functionality is distributed among multiple servers. In various implementations, the one or more networks 120 include one or more wired or wireless wide area networks (WANs), such as the Internet, one or more wired or wireless local area networks (LANs), one or more cellular networks, or a combination thereof. In various implementations, client devices 130, 132, and 134, or any combination thereof, include any of a variety of user electronic devices used for receipt and display of encoded video streams, such as a laptop computer, desktop computer, tablet computer, smart phone, smart watch, video game console, vehicle entertainment system, network-connected appliance, and the like.

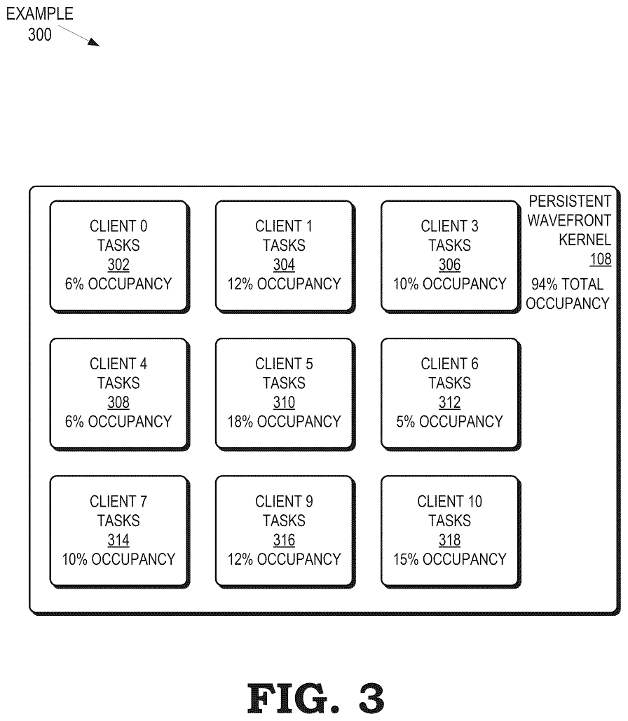

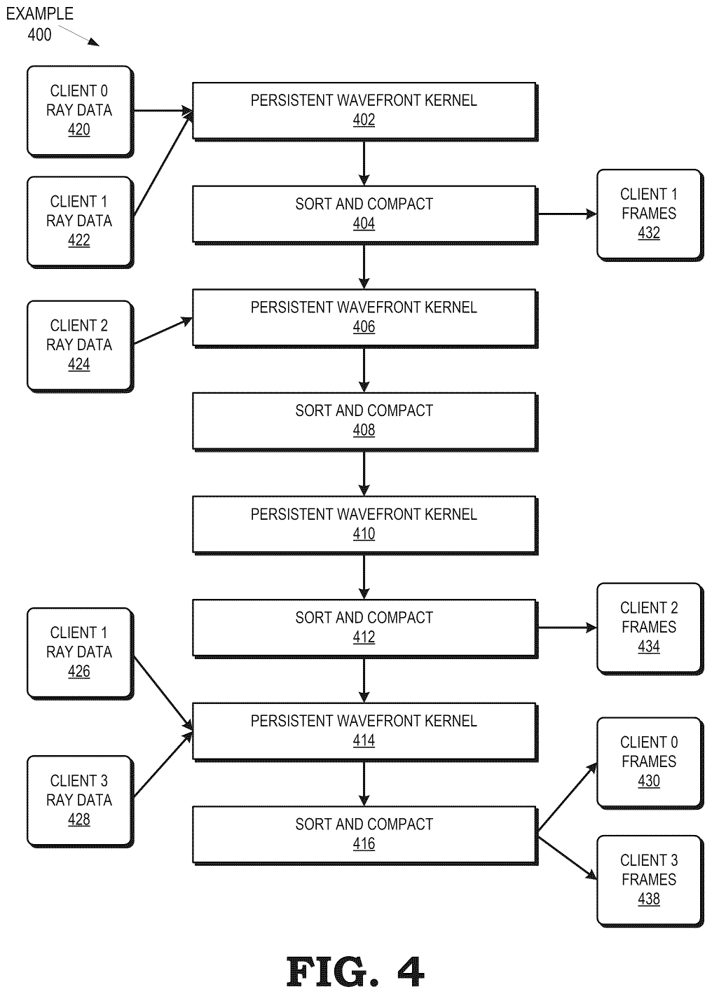

As a general operational interview, server 102 receives requests 140, 142, and 144 for streamed content from client devices 130, 132, and 134, respectively. In some implementations, requests 140, 142, and 144 are received directly. In other implementations, requests 140, 142, and 144 are received indirectly (e.g., via a front-end server or system). In some implementations, requests 140, 142, and 144 include requests for server 102 to generate video data that is generated via ray tracing tasks. Accordingly, requests for the ray tracing tasks are forwarded to at least a portion of server 102. As further described below with reference to FIG. 4, in some cases, requests 140, 142, and 144 are received simultaneously or at similar times. In other cases, one or more of requests 140, 142, and 144 are received before or later than others of requests 140, 142, and 144. In some cases, rather than directly requesting video data, requests 140, 142, and 144 include client data, such as positional information for a player in a video game. In response to requests 140, 142, and 144, server 102 identifies that each of requests 140, 142, and 144 corresponds to a same ray tracing context within persistent wavefront kernel 110 (e.g., by matching ray tracing tasks of a first request to ray tracing data or a ray tracing context and matching ray tracing tasks of a second request to the ray tracing data or ray tracing context), renders a sequence of video frames for each of client devices 130, 132, and 134, processes this sequence into streams 150, 152, and 154 of rendered video frames, and transmits the streams to client devices 130, 132, and 134, respectively, via one or more networks 120. As the streams 150, 152, and 154 are received, client devices 130, 132, and 134 each provide a representation of the resulting stream of rendered video frames for display at the corresponding display device. In some implementations, at least a portion of the rendering of video frames includes processing ray tracing data to generate frames of a scene of persistent wavefront kernel 110. In some cases, because each of client devices 130, 132, and 134 are requesting video content of the scene, the ray tracing processing is performed in parallel as described below with reference to FIGS. 3-5. In some implementations, streams 150, 152, and 154 are encoded and client devices 130, 132, and 134 decode the respective streams as part of providing the representations of the resulting streams for display. In some implementations, a respective frame buffer of server 102 is allocated for each of client devices 130, 132, and 134, rendering the frames, processing the streams or both includes saving data for client devices 130, 132, and 134 in the respective frame buffers, and transmitting streams 150, 152, and 154 to client devices 130, 132, and 134 includes reading the streams from the respective frame buffers.

To illustrate, in a cloud-based gaming context, server 102 executes an instance of a video program 104 that renders a stream 150 of video frames based on gameplay controlled by user input received from client device 130. Stream 150 of video frames for client device 130 is rendered by performing a first set of ray tracing tasks. Stream 150 is transmitted to client device 130 for display. Similarly, server 102 executes an instance of the video program 104 that renders a stream 152 of video frames based on gameplay controlled by user input received from client device 132. Stream 152 of video frames for client device 132 is rendered by performing a second set of ray tracing tasks. Stream 152 is transmitted to client device 132 for display. Additionally, server 102 executes an instance of the video program 104 that renders a stream 154 of video frames based on gameplay controlled by user input received from client device 134. Stream 154 of video frames for client device 134 is rendered by performing a third set of ray tracing tasks. Stream 154 is transmitted to client device 134 for display. In some implementations, at least some of the first set of ray tracing tasks, the second set of ray tracing tasks, the third set of ray tracing tasks, or any combination thereof are performed in parallel such that processor occupancy of server 102 is increased and the long-tail problem discussed above is mitigated.

Video game applications or other applications that generate rendered graphical content and which are executed by server 102 typically employ one or more 2D or 3D graphics effects implemented via execution of corresponding graphics effects operations, including ray tracing operations. To facilitate execution of these ray tracing operations, server 102 includes ray tracing engine 106. In some implementations, ray tracing engine 106 is circuitry configured to perform ray tracing operations, such as ray casting, path tracing, BVH traversal, denoising filtering, and the like, or any combination thereof. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some implementations, one or more of the operations of ray tracing engine 106 are executed by software instructions that manipulate one or more processing elements (e.g., processor cores, compute units, and the like) to perform the corresponding operations.

To execute these ray tracing operations, ray tracing engine 106 employs ray tracing data such as ray tracing context 108. Ray tracing context 108 includes one or more data structures that store information used by the rendering engine to perform ray tracing operations for a persistent wavefront kernel, such as persistent wavefront kernel 110. For example, in some implementations, ray tracing context 108 includes one or more of a scene graph for a scene of a ray tracing context associated with persistent wavefront kernel 110, a BVH employed by ray tracing engine 106 to accelerate identification of ray intersections with objects indicated by the scene graph, geometry and texture information for objects in the scene, and the like or any combination thereof. Conventionally, a server employs a different ray tracing context to perform ray tracing operations for different client devices, and thereby generate the different video streams for the client devices. However, maintaining a separate copy of the ray tracing context consumes a relatively high amount of system resources, such as memory and power. Further, in some cases, the ray tracing contexts for the different clients are substantially the same or store the same information. For example, in some cases, the ray tracing context represents the object of a game world, or a portion thereof, for a game program, and different client devices interact with that same game world or portion. In these cases, the ray tracing context for each of the client devices is substantially the same, and therefore the multiple copies of the ray tracing contexts consume system resources without providing a corresponding benefit. In some cases, ray tracing context 108 is referred to herein more generally as ray tracing data.

Accordingly, to mitigate the consumption of resources, in at least one implementation, server 102 uses ray tracing context 108 to generate streams 150, 152, and 154. That is, server 102 employs ray tracing engine 106 to perform ray tracing operations for client devices 130, 132, and 134 using the same ray tracing context 108. In some cases, the ray tracing operations are performed in parallel. Based on the corresponding ray tracing operations, server 102 renders the video frames for streams 150, 152, and 154. Because server 102 uses the same ray tracing context 108 to generate streams 150, 152, and 154, server 102 does not have to maintain different copies of a ray tracing context for each client device, nor does the server 102 perform context switches when changing between client streams at the server 102. The server 102 is thus able to generate streams 150, 152, and 154 using fewer memory and other system resources. Additionally, because at least a portion of ray tracing operations of one of streams 150, 152, and 154 is performed in parallel with (concurrently with) at least a portion of ray tracing operations of another one of streams 150, 152, and 154, the similar amounts of operations performed to perform the ray tracing operations allow server 102 to have a higher throughput, as compared to a system that processes streams 150, 152, and 154 sequentially. In some cases, throughput is higher even if different rays are cast for different client devices to generate frames of within a same ray tracing context or of a same scene.

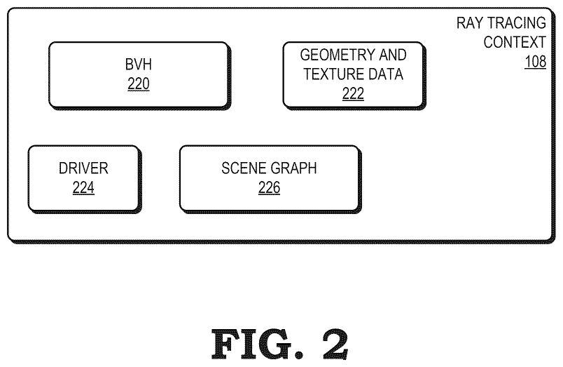

FIG. 2 illustrates an example of ray tracing context 108 of FIG. 1 in accordance with some implementations. In the depicted example, ray tracing context 108 includes BVH 220, scene graph 226, driver 224, and geometry and texture data 222. Scene graph 226 is a data structure that encodes objects of a scene or environment. Scene graph 226 encodes the objects as nodes connected via pairwise relationships as edges. For example, in some implementations, video game program 104 implements a virtual game “world” or environment, where the environment includes a set of graphical objects, and scene graph 226 encodes the objects of the environment as nodes, and the relationships between the objects as connections between the nodes. For example, in some implementations scene graph 226 maintains a position, animated state, other characteristics of actors or other game objects, or any combination thereof. In some implementations, ray tracing engine 106 performs selected ray tracing operations, or portions thereof, by traversing scene graph 226 to, for example, transform one or more rays, construct one or more acceleration structures such as BVH 220, and the like. Driver 224 is a software module (that is, a set of instructions executed at a processor) that provides an interface between the hardware of ray tracing engine 106 and other software.

Geometry and texture data 222 includes one or more data structures that store information indicating the geometry and texture of objects in a scene or environment. For example, in some implementations, geometry and texture data 222 stores geometry and texture information for one or more of the objects represented in scene graph 226. In some implementations, ray tracing engine 106 executes operations that calculate how a ray reflects off a designated object, and these calculations depend upon the shape (that is, the geometry) and texture of the object. Accordingly, to perform these reflection operations, ray tracing engine 106 employs geometry and texture data 222.

BVH 220 includes a data structure that represents a set of geometric objects within a scene to be rendered. The geometric objects (e.g., triangles or other primitives) are enclosed in bounding boxes or other bounding volumes that form leaf nodes of BVH 220, and then these nodes are grouped into sets, with each set enclosed in its own bounding volume that is represented by a parent node on the tree structure, and these sets then are bound into larger sets that are similarly enclosed in their own bounding volumes that represent a higher parent node on the tree structure, and so forth, until there is a single bounding volume representing the top node of BVH 220 and which encompasses all lower-level bounding volumes.

In some implementations, to perform some ray tracing operations, ray tracing engine 106 uses BVH 220 to identify potential intersections between generated rays and the geometric objects in the scene by traversing the nodes of the tree. At each node being traversed, ray tracing engine 106 compares a ray of interest with the bounding volume of that node to determine if there is an intersection, and if so, continuing on to a next node in the tree, where the next node is identified based on the traversal algorithm, and so forth.

FIG. 3 illustrates a block diagram of an example 300 illustration of occupancy of system resources by a group of nine clients' tasks used to generate frames of a ray tracing context for corresponding client devices within persistent wavefront kernel 110 of FIG. 1 at a point in time. In the illustrated implementation, the various client tasks each correspond to an occupancy of overall available processing resources of ray tracing engine 106 allocated to persistent wavefront kernel 110. In the illustrated example, because all of the illustrated client tasks are within persistent wavefront kernel 110, the client tasks share a same ray tracing context and a same scene. In the example, at the illustrated point in time, client 0 tasks 302 represent 6% occupancy, client 1 tasks 304 represent 12% occupancy, client 3 tasks 306 represent 10% occupancy, client 4 tasks 308 represent 6% occupancy, client 5 tasks 310 represent 18% occupancy, client 6 tasks 312 represent 5% occupancy, client 7 tasks 314 represent 10% occupancy, client 9 tasks 316 represent 12% occupancy, and client 10 tasks 318 represent 15% occupancy. As a result, in example 300, total occupancy is 94%. Such an occupancy value is better than is normally achieved by processing tasks of client devices separately using separate ray tracing contexts (e.g., due to the long-tail problem discussed above and due to inefficient resource distribution due to keeping the processing separate).

FIG. 4 illustrates a flow diagram of an example 400 of a ray tracing engine, such as ray tracing engine 106 of FIG. 1, generating frames of a ray tracing context for multiple client devices in parallel in accordance with some implementations. In example 400, the video streaming system receives client ray data at various times and performs ray tracing operations within a persistent wavefront kernel on that ray data in parallel. As illustrated, tasks corresponding to clients are added and completed asynchronously while maintaining occupancy of processing resources.

In the illustrated example, client 0 ray data 420 and client 1 ray data 422 is received (e.g., from the corresponding client devices or from another part of server 102). Client 0 ray data 420 and client 1 ray data 420 are batch processed together (e.g., ray tracing operations are performed in parallel) at persistent wavefront kernel 402. In some implementations, each “persistent wavefront kernel” step corresponds to processing a same number of rays per client (e.g., one primary or secondary ray or one primary and secondary ray or two secondary rays). After an amount of time used to process an iteration of the persistent wavefront kernel (e.g., an amount of time corresponding to processing a primary ray or an amount of time corresponding to process a specified number of rays), sort and compact 404 is performed. In a sort portion of sort and compact 404, the ray tracing engine sorts remaining ray processing tasks to improve coherency (e.g., sorting ray processing tasks based on direction, origin, or sign). In a compact portion of sort and compact 404, ray processing tasks corresponding to terminated rays (for which no more work is to be performed) are removed. When all tiles in a frame are completed, the frame is ready to be posted or streamed. Accordingly, in example 400, the ray tracing engine determines that processing of client 1 ray data 422 is complete, resulting in client 1 frames 432. The ray tracing engine causes client 1 frames 432 to be sent to client 1 (e.g., by saving client 1 frames 432 in a frame buffer corresponding to client 1 or via another method such as sending client 1 frames 432 directly). In some implementations, the ray tracing engine additionally organizes remaining portions of client 0 ray data 420 for additional processing. Although sorting and compacting is described in the above example with sorting occurring before compacting, in some implementations, compacting occurs before sorting. In some implementations, some or all of the sorting, compacting, or both occurs concurrently.

Accordingly, in the illustrated example, at persistent wavefront kernel 406, client 0 ray data 420 continues to be processed. Additionally, client 2 ray data 424 is received and is batch processed in parallel with client 0 ray data 420. At sort and compact 408, the ray tracing engine determines that the processing of client 0 ray data 420 and client 2 ray data 424 is to continue. Further, in some implementations, the ray tracing engine organizes remaining portions of client 0 ray data 420 and client 2 ray data 424. At persistent wavefront kernel 410, no additional client ray data is received, but the ray tracing engine still batch processes client 0 ray data 420 and client 2 ray data 424 in parallel. At sort and compact 412, the ray tracing engine determines that processing of client 2 ray data 424 is complete, resulting in client 2 frames 434. The ray tracing engine causes client 2 frames 434 to be sent to client 2. Further, in some implementations, the ray tracing engine organizes remaining portions of client 0 ray data 420.

At persistent wavefront kernel 414, client 0 ray data 420 continues to be processed. Additionally, client 1 ray data 426 (additional ray data for client 1) and client 3 ray data 428 are received and are batch processed in parallel with client 0 ray data 420. At sort and compact 416, the ray tracing engine determines that processing of client 0 ray data 420 and the processing of client 3 ray data 428 are complete, resulting in client 0 frames 430 and client 3 frames 438. The ray tracing engine causes client 0 frames 430 to be sent to client 0 and client 3 frames 438 to be sent to client 3. Further, in some implementations, the ray tracing engine organizes remaining portions of client 1 ray data 428 for additional processing. Accordingly, an example illustrating how a processing engine batch processes data for multiple client devices in parallel is presented.

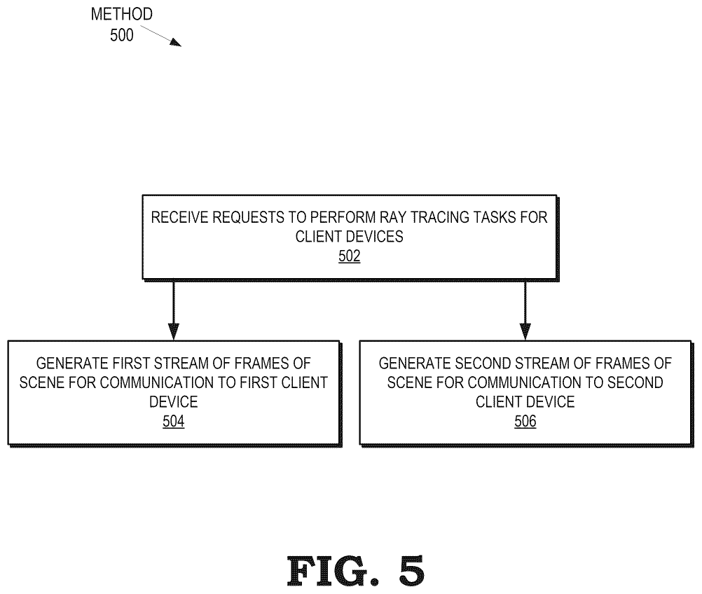

FIG. 5 illustrates a flow diagram of a method 500 of employing the same ray tracing context to perform ray tracing operations and generate multiple corresponding streams of video frames of a ray tracing context for multiple client devices in parallel in accordance with some implementations. Method 500 is described with respect to an example implementation at video streaming system 100 of FIG. 1. In some implementations, method 500 is initiated by one or more processors in response to one or more instructions stored by a computer readable storage medium.

At block 502, requests to perform ray tracing tasks for client devices are received. For example, ray tracing engine 106 receives requests to perform ray tracing tasks for client device 130 and for client device 134. In some cases, the requests are received at the same time. In other cases, the requests are received at different times.

At block 504, a first stream of frames of a scene is generated for communication to a first client device. For example, frames of stream 150 are generated for communication to client device 130. At block 506, a second stream of frames of the scene are generated for communication to a second client device in parallel with generating the first stream of frames. For example, based on client device 134 requesting data for a same scene as client device 130, at least some frames of stream 154 are generated for communication to client device 134 in parallel with at least some frames of stream 150. Accordingly, a method of employing the same ray tracing context to perform ray tracing operations and generate multiple corresponding streams of video frames of a ray tracing context for multiple client devices in parallel is depicted.

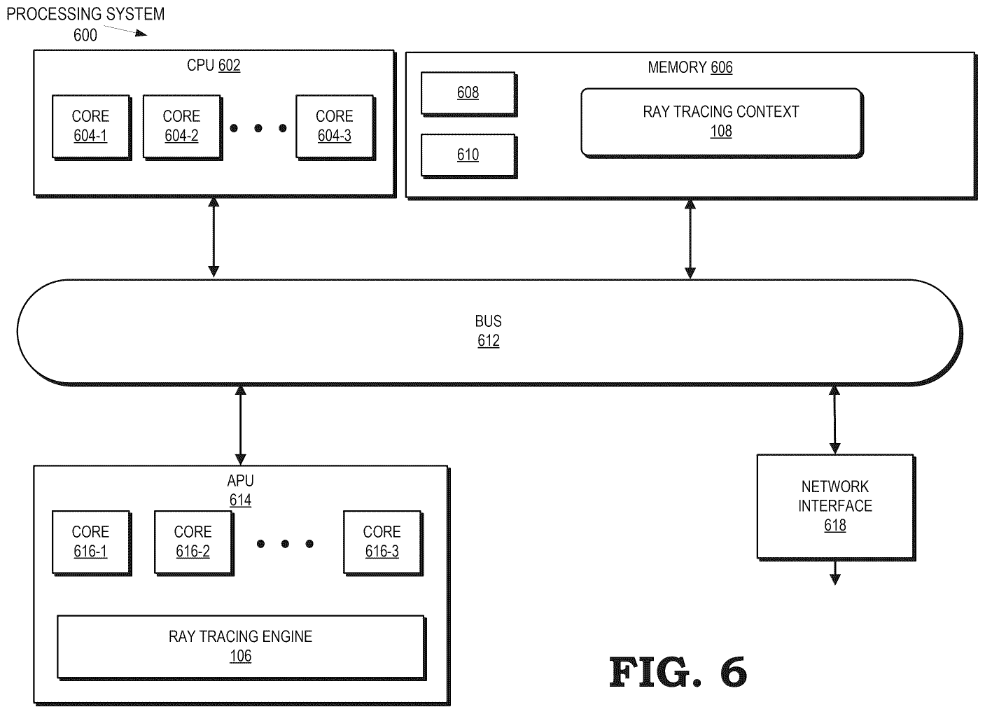

FIG. 6 illustrates an example of a processing system 600 that implements a server (e.g., a processing server) of a video streaming system that generates frames of a ray tracing context for multiple client devices in parallel in accordance with some implementations. In some implementations, processing system 600 implements server 102 and generates video streams for communication to multiple client devices based on ray tracing context 108. To this end, processing system 600 includes or has access to memory 606 or another storage component implemented using a non-transitory computer-readable medium, for example, a dynamic random-access memory (DRAM). However, in some implementations, memory 606 is implemented using other types of memory including, for example, static random-access memory (SRAM), nonvolatile RAM, and the like. According to some implementations, memory 606 includes an external memory implemented external to the processing units implemented in processing system 600. Processing system 600 also includes bus 612 to support communication between entities implemented in processing system 600, such as memory 606. Some implementations of processing system 600 include other buses, bridges, switches, routers, and the like, which are not shown in FIG. 6 in the interest of clarity.

The techniques described herein are, in different implementations, employed at accelerated processing unit (APU) 614. APU 614 includes, for example, vector processors, coprocessors, graphics processing units (GPUs), general-purpose GPUs (GPGPUs), non-scalar processors, highly parallel processors, artificial intelligence (AI) processors, inference engines, machine learning processors, other multithreaded processing units, scalar processors, serial processors, or any combination thereof. APU 614 renders scenes within a screen space (e.g., the space in which a scene is displayed) according to one or more applications 610 for streaming to one or more client devices. For example, APU 614 renders graphics objects (e.g., sets of primitives) of a scene of a ray tracing context in a screen space (e.g., display space) to be displayed to produce values of pixels in the form of video frames, and the video frames are provided to a network interface 618 that communicates the video frames to the corresponding client devices (e.g., client devices 130 and 134) via one or more networks (e.g., one or more networks 120). In some implementations, network interface 618 communicates with each client device via a respective network connection (not shown). To render these graphics objects, APU 614 includes a plurality of processor cores 616-1 to 616-3 that execute instructions concurrently or in parallel. For example, the APU 614 executes instructions from one or more graphics pipelines using a plurality of processor cores 616 to render one or more graphics objects. A graphics pipeline includes, for example, one or more steps, stages, or instructions to be performed by APU 614 in order to render one or more graphics objects for a scene. As an example, a graphics pipeline includes data indicating an assembler stage, vertex shader stage, hull shader stage, tessellator stage, domain shader stage, geometry shader stage, binner stage, rasterizer stage, pixel shader stage, output merger stage, or any combination thereof to be performed by one or more processor cores 616 of APU 614 in order to render one or more graphics objects for a scene. In some implementations, one or more stages of the graphics pipeline includes, or employs, ray tracing engine 106 to perform ray tracing operations, including operations based on ray tracing context 108.

In implementations, one or more processor cores 616 of APU 614 each operate as a compute unit configured to perform one or more operations for one or more instructions received by APU 614. These compute units each include one or more single instruction, multiple data (SIMD) units that perform the same operation on different data sets to produce one or more results. For example, APU 614 includes one or more processor cores 616 each functioning as a compute unit that includes one or more SIMD units to perform operations for one or more instructions from a graphics pipeline. To facilitate one or compute units performing operations for instructions from a graphics pipeline, APU 614 includes one or more command processors (not shown for clarity). Such command processors, for example, include hardware-based circuitry, software-based circuitry, or both configured to execute one or more instructions from a graphics pipeline by providing data indicating one or more operations, operands, instructions, variables, register files, or any combination thereof to one or more compute units necessary for, helpful for, or aiding in the performance of one or more operations for the instructions. Though the example implementation illustrated in FIG. 6 presents APU 614 as having three processor cores (616-1, 616-2, 616-3) representing an arbitrary number of cores; the number of processor cores 616 implemented in APU 614 is a matter of design choice. As such, in other implementations, APU 614 can include any number of processor cores 616. Some implementations of APU 614 are used for general-purpose computing. For example, APU 614 executes instructions such as program code 608 for one or more applications 610 stored in memory 606 and APU 614 stores information in the memory 606 such as the results of the executed instructions. Memory 606 also stores ray tracing context 108 for use by the ray tracing engine 106.

In some implementations, APU 614 is configured to perform ray tracing and other graphics operations. To facilitate the performance of such operations for instructions of a graphics pipeline, each graphics core of APU 614 is associated with (e.g., configured to communicate with) a respective command processor of APU 614 configured to provide data (e.g., operations, operands, instructions, variables, register files) to one or more compute units of a graphics core necessary for, helpful for, or aiding in the performance of the operations for a respective set of instructions. Because each graphics core is associated with a respective command processor configured to provide data based on a respective set of instructions, the graphics cores are enabled to render different graphics objects at different times. That is to say, two or more graphics cores are configured to concurrently render different graphics objects such that, for example, a first graphics core renders a first graphics object, and a second graphics core concurrently renders a second graphics object different from the first graphics object. In some cases, two or more graphics cores are configured to concurrently render different graphics objects of a same ray tracing context for different client devices.

According to implementations, to generate video frames for streaming, the graphics cores of APU 614 are configured to generate ray tracing commands for ray tracing engine 106. In response to the ray tracing commands, ray tracing engine 106 employs the data structures of ray tracing context 108 to execute one or more ray tracing operations. Such data structures, for example, each include levels of nodes representing hierarchically arranged bounding boxes, bounding volumes, or both that each encompasses one or more graphics objects (e.g., sets of triangles or other primitives), portions of one or more graphics objects (e.g., meshlets), or both within a scene to be rendered in a screen space. As an example, in some implementations ray tracing context 108 includes a BVH (e.g., BVH 220 of FIG. 2) representing two or more hierarchically arranged bounding volumes that each encompass graphics objects, portions of graphics objects, or both of a scene to be rendered within a screen space. As another example, in some implementations the ray tracing context 108 includes, in addition to or instead of the BVH, a scene graph, a device driver, geometry and texture data, or any combination thereof.

Processing system 600 also includes a central processing unit (CPU) 602 that is connected to bus 612 and communicates with the APU 614 and memory 606 via bus 612. CPU 602 includes a plurality of processor cores 604-1 to 604-3 that execute instructions concurrently or in parallel. Though in the example implementation illustrated in FIG. 6, three processor cores (604-1, 604-2, 604-3) are presented representing an arbitrary number of cores, the number of processor cores 604 implemented in the CPU 602 is a matter of design choice. As such, in other implementations, the CPU 602 can include any number of processor cores 604. In some implementations, the CPU 602 and APU 614 have an equal number of processor cores 604, 616 while in other implementations, the CPU 602 and APU 614 have differing numbers of processor cores 604, 616. Processor cores 604 execute instructions such as program code 608 for one or more applications 610 (e.g., video game program 104) stored in memory 606 and CPU 602 stores information in the memory 606 such as the results of the executed instructions. CPU 602 is also able to initiate graphics processing, including one or more ray tracing operations, by issuing commands (e.g., draw calls) to APU 614 via bus 612.

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A processing server comprising:
a memory configured to store ray tracing data for a scene; and
a processor configured to:
receive requests to perform ray tracing tasks to depict at least a first portion of the scene for a first client device and at least a second portion of the scene for a second client device, wherein the first client device is different from the second client device;
generate for communication to the first client device, based on the ray tracing data, a first stream of frames of the scene; and
generate for communication to the second client device, in parallel with generating the first stream of frames, based on the ray tracing data, at least a portion of a second stream of frames of the scene, wherein the second stream of frames is different from the first stream of frames.

2. The processing server of claim 1, wherein generating the second stream of frames is performed in response to determining that the scene of the first stream of frames is the same as the scene of the second stream of frames.

3. The processing server of claim 2, wherein determining that the scene of the first stream of frames is the same as the scene of the second stream of frames comprises determining that the ray tracing tasks for the first client device share a same bounding volume hierarchy (BVH) of the ray tracing data as the ray tracing tasks for the second client device.

4. The processing server of claim 1, further comprising:
a network interface configured to communicate with the first client device and the second client device via a network.

5. The processing server of claim 4, wherein the network interface is configured to communicate with the first client device via a first network connection and the network interface is configured to communicate with the second client device via a second network connection.

6. The processing server of claim 1, wherein the processor is further configured to:
save the first stream of frames in a first portion of the memory allocated to the first client device; and
save the second stream of frames in a second portion of the memory allocated to the second client device.

7. The processing server of claim 6, wherein the processor is further configured to:
cause the first stream of frames to be sent to the first client device prior to finishing generating the second stream of frames.

8. The processing server of claim 7, wherein the processor is further configured to:
subsequent to generating at least a portion of the first stream of frames and prior to causing the first stream of frames to being sent, receiving a request to depict at least a third portion of the scene for a third client device, wherein the third client device is different from the first client device and from the second client device; and
generate, in parallel with generating the first stream of frames, based on the ray tracing data, at least a portion of a third stream of frames of the scene for communication to the third client device, wherein the third stream of frames is different from the first stream of frames and from the second stream of frames.

9. The processing server of claim 6, wherein the first portion of the memory is a first frame buffer allocated to the first client device, and wherein the second portion of the memory is a second frame buffer allocated to the second client device.

10. A method comprising:
receiving requests to perform ray tracing tasks to depict at least a first portion of a scene for a first client device and at least a second portion of the scene for a second client device, wherein the first client device is different from the second client device;
generating, based on ray tracing data, a first stream of frames of the scene for communication to the first client device; and
generating, in parallel with generating the first stream of frames and based on the ray tracing data, a second stream of frames of the scene for communication to the second client device, wherein the second stream of frames is different from the first stream of frames.

11. The method of claim 10, wherein generating the second stream of frames comprises batch processing shadow rays for the second stream of frames with shadow rays for the first stream of frames.

12. The method of claim 10, wherein generating the second stream of frames comprises batch processing fifth ray tracing bounces for the second stream of frames with second ray tracing bounces for the first stream of frames.

13. The method of claim 10, further comprising:
sending the first stream of frames to the first client device via a first network connection; and
sending the second stream of frames to the second client device via a second network connection.

14. The method of claim 10, wherein the first stream of frames and the second stream of frames are generated within a same persistent wavefront kernel.

15. A processing server comprising:
a memory configured to store ray tracing data of a scene; and
a processor configured to:
compare first ray tracing tasks to be performed for a first client device to the ray tracing data;
in response to the first ray tracing tasks corresponding to the ray tracing data, generate a first stream of frames of the scene for communication to the first client device via a network interface;
compare second ray tracing tasks to be performed for a second client device to the ray tracing data, wherein the first client device is different from the second client device; and
in response to the second ray tracing tasks corresponding to the ray tracing data, in parallel with generating the first stream of frames, generate at least a portion of a second stream of frames of the scene for communication to the second client device via the network interface, wherein the second stream of frames is different from the first stream of frames.

16. The processing server of claim 15, wherein generating the second stream of frames in parallel with the first stream of frames is performed in response to determining that the first ray tracing tasks share a same bounding volume hierarchy (BVH) of the ray tracing data as the second ray tracing tasks.

17. The processing server of claim 16, wherein a first ray for the first client device traces a different path through the scene than a second ray for the second client device, and wherein the first ray and the second ray are processed in parallel.

18. The processing server of claim 15, wherein the first ray tracing tasks corresponding to the ray tracing data comprises determining that the scene of the first stream of frames corresponds to the ray tracing data.

19. The processing server of claim 15, wherein the processor is further configured to:
subsequent to sending the second stream of frames to the second client device, generate at least a portion of the first stream of frames.

20. The processing server of claim 19, wherein the processor is further configured to:
in parallel with generating the first stream of frames but subsequent to sending the second stream of frames to the second client device, generate at least a portion of a third stream of frames of the scene for communication to the second client device via the network interface, wherein the third stream of frames is different from the first stream of frames and from the second stream of frames.
